(19) United States
(12) Patent Application Publication
(10) Pub. No.: US 2010/0328464 A1
(43) Pub. Date: Dec. 30, 2010

(54) CAR-MOUNT TRAFFIC CONDITION SURVEILLANCE DEVICE

(75) Inventor: RONG-HER CHOU, Yu-Lin Hsien (TW)

Correspondence Address: WPAT, PC;INTELLECTUAL PROPERTY ATTORNEYS, 7225 BEVERLY ST., ANNANDALE, VA, 22003, US

(73) Assignee: TECH-CAST MFG. CORP., Yu-Lin Hsien (TW)

(21) Appl. No.: 12/494,712

(22) Filed: Jun. 30, 2009

(51) Int. Cl. H04N 7/18

(52) U.S. Cl. 348/149; 348/E07.085

(57) ABSTRACT

A car-mount traffic condition surveillance device includes an image acquisition unit, a control unit, an input unit, an image display unit, and a power supply unit. The image acquisition unit includes first and second image acquisition units for respectively acquiring images of street corners or lane entrances closely located in front of the left and the right side of the car. The input unit can send an actuating signal for the control unit to transmit the images acquired by the first and second image acquisition units to the image display unit for displaying on a split screen, allowing the drive to view the images at the same time so as to avoid collision of the car with another car unexpectedly coming out from any of the street corners or lane entrances.

### FIELD OF THE INVENTION

The present invention relates to a car-mount traffic condition surveillance device, and more particularly to a car-mount traffic condition surveillance device for acquiring images of street corners or small lane entrances located closely in front of two lateral sides of a car to help a driver to avoid collision of the car with another car unexpectedly coming out from any of the street corners or the lane entrances.

### BACKGROUND OF THE INVENTION

Following the rapid progress and development in the modern society, the large quantity of cars in cities complicates and brings chaos to the city traffic. In addition, people living in the cities have tense and busy life to always race with time. Traffic accidents happen here and there because most drivers try to rush through road crossings.

A traffic accident easily happens particularly when a car rushes through a small street corner or a small lane entrance and collides with another car unexpectedly coming out therefrom. It is uneasy for the driver to know in advance whether there would be any car coming out from the next street corner or lane entrance. In the case of a passenger car that usually has a relatively long head, when the driver has moved to a position allowing him or her to see any car coming out from a street corner closely located in front of either side of the passenger car, it is already too late for the driver to avoid colliding with the car sidewardly approaching to the street corner.

On the other hand, when driving on a country road with low traffic flow, the driver would usually unconsciously accelerate the car. When the car passes a road crossing or a small lane entrance at high speed and there is another car coming out from the road crossing or the lane entrance, it would be almost impossible for the driver to make any response but to collide with the unexpected car. Sometimes, the driver completely neglects the small crossing when rushing through the road. A serious accident would usually happen under this circumstance to injure or even kill the driver and/or other passengers.

### SUMMARY OF THE INVENTION

A primary object of the present invention is to provide a car-mount traffic condition surveillance device capable of providing real-time images of street corners or lane entrances closely located in front of two lateral sides of a car to help a driver to avoid collision of the car with another car unexpectedly coming out from any of the street corners or lane entrances.

Another object of the present invention is to provide a car-mount traffic condition surveillance device capable of providing a real-time image of a rear side of a car, so as to prevent the car from colliding with an obstacle closely located behind the car.

To achieve the above and other object, the car-mount traffic condition surveillance device according to the present invention includes an image acquisition unit, a control unit, an input unit, an image display unit, and a power supply unit. The image acquisition unit includes first and second image acquisition units mounted to front left and front right sides, respectively, of car to acquire images in front of left and right sides of the car. The control unit is able to transmit the images acquired by the first and the second image acquisition unit to the image display unit, so that the two images are simultaneously shown at a left and a right part, respectively, of a split screen of the image display unit, allowing a driver to watch for the traffic conditions of street corners or lane entrances closely located in front of two lateral sides of the car 1 via the image display unit at the same time. The power supply unit supplies the power needed by all other units of the car-mount traffic condition surveillance device to operate normally.

The input unit includes a manual switch for sending an actuating signal to the control unit, so that the control unit, on receipt of the actuating signal, can immediately transmit the images acquired by the first and the second image acquisition unit to the image display unit for displaying on the split screen thereof. According to an operable embodiment, each time the manual switch is pushed to send an actuating signal to the control unit, the image display unit can be controlled by the control unit to continuously display the images acquired by the image acquisition unit for a period of 30 seconds to 1 minute.

The input unit further includes a turning signal switch for sending a left-turn signal or a right-turn signal to the control unit, so that the control unit can immediately transmit the image acquired by the first or the second image acquisition unit, respectively, to the image display unit for display.

The image display unit can further include a third image acquisition unit mounted to a rear side of the car for acquiring an image showing a condition at the rear side of the car. And, the input unit can further include a gear-shift detector. When the driver pushes the gear shift rod to reverse gear, the gear-shift detector will transmit a reverse-gear signal to the control unit. On receipt of the reverse-gear signal from the gear-shift detector, the control unit will immediately transmit the image acquired by the third image acquisition unit to the image display unit for display.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a car-mount traffic condition surveillance device according to a first embodiment of the present invention;

FIG. 2 shows the car-mount traffic condition surveillance device of the present invention in use;

FIG. 3 schematically shows a split screen of an image display unit included in the present invention for displaying two images of traffic condition at the same time;

FIG. 4 schematically shows the image display unit of FIG. 3 displays only the image indicating the traffic condition at a street corner or lane entrance closely located in front of the left side of the car;

FIG. 5 schematically shows the image display unit of FIG. 3 displays only the image indicating the traffic condition at a street corner or lane entrance closely located in front of the right side of the car;

FIG. 6 is a block diagram of a car-mount traffic condition surveillance device according to a second embodiment of the present invention; and

FIG. 7 schematically shows the image display unit of the present invention displays an image indicating the condition at a rear side of the car.

### DETAILED DESCRIPTION OF THE PREFERRED EMBODIMENTS

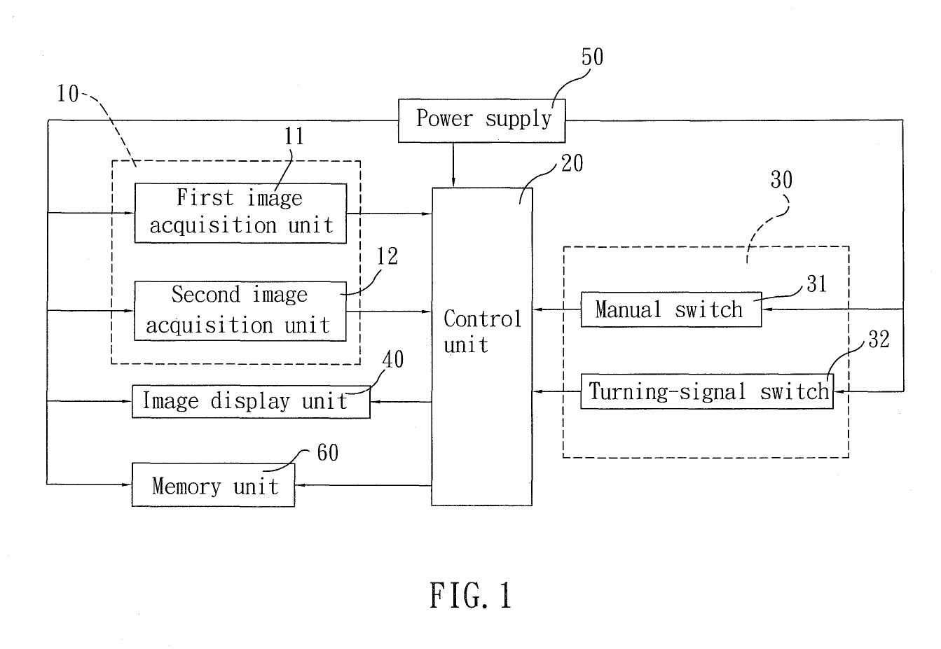

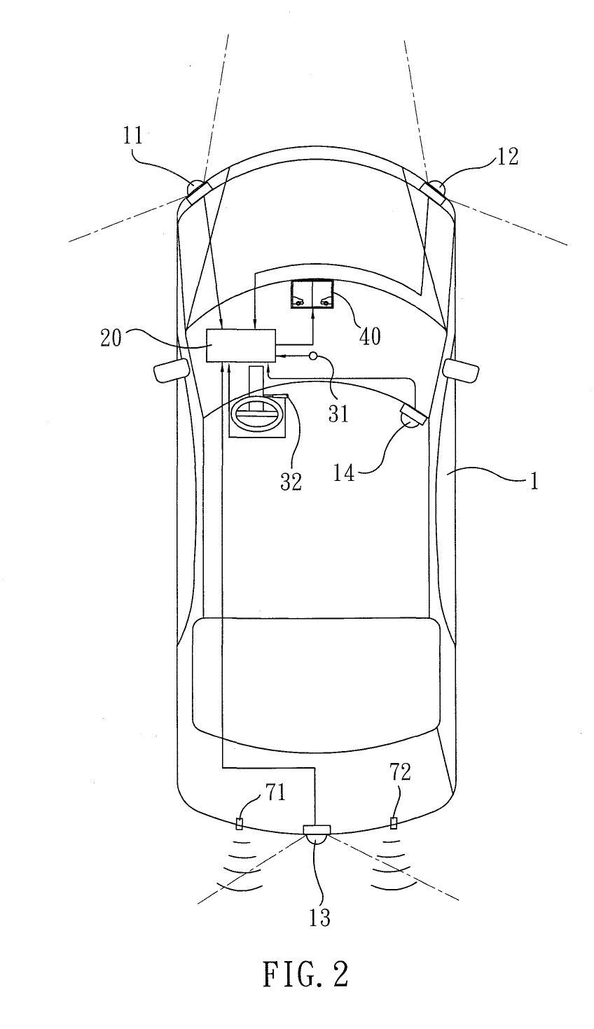

Please refer to FIG. 1 that is a block diagram of a car-mount traffic condition surveillance device according to a first embodiment of the present invention, and to FIG. 2 that shows the car-mount traffic condition surveillance device of the present invention in use. As shown, the car-mount traffic condition surveillance device is mounted on a car 1 to acquire images showing traffic conditions at street corners or lane entrances closely located in front of two sides of the car 1. The car-mount traffic condition surveillance device includes an image acquisition unit 10, a control unit 20, an input unit 30, an image display unit 40, and a power supply unit 50. The control unit 20 is electrically connected to the image acquisition unit 10, the input unit 30 and the image display unit 40; and the power supply unit 50 supplies power needed for all other units or components of the car-mount traffic condition surveillance device to operate normally. In an embodiment of the present invention, the power supply unit 50 can be the power supply originally equipped on the car 1.

The image acquisition unit 10 includes a first image acquisition unit 11 arranged at the front left side of the car 1 for acquiring images indicating the traffic condition of street corners or lane entrances closely located in front of the left side of the car 1; and a second image acquisition unit 12 arranged at the front right side of the car 1 for acquiring images indicating the traffic condition of street corners or lane entrances closely located in front of the right side of the car 1.

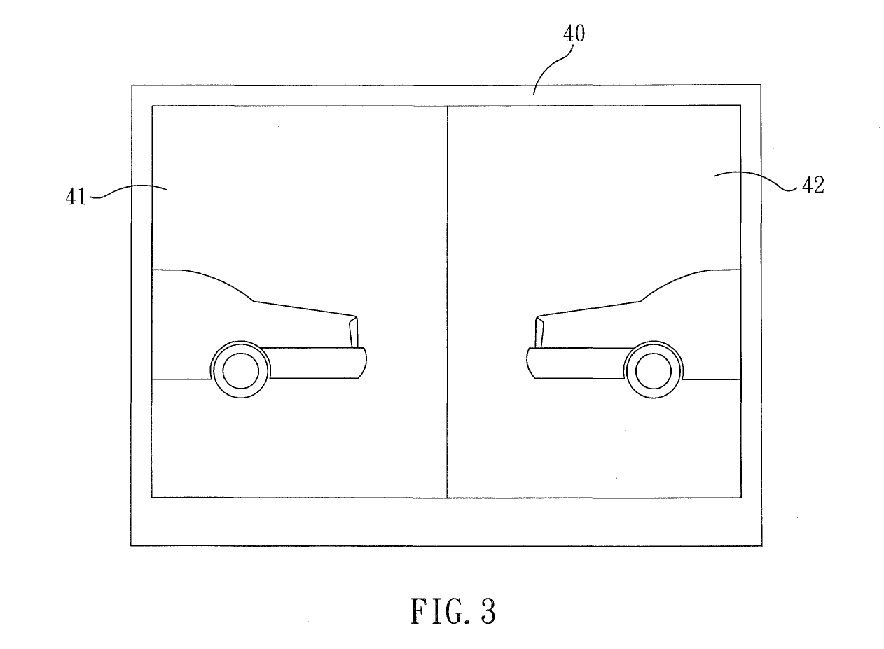

The control unit 20 can transmit the images acquired by the image acquisition unit 10 to the image display unit 40 for display. The control unit 20 is able to show the images acquired by the first and the second image acquisition unit 11, 12 on a left and a right part, respectively, of a split screen of the image display unit 40, so that a driver can simultaneously watch for the traffic conditions of the street corners or lane entrances closely located at two lateral sides of the car 1 via the image display unit 40, as shown in FIG. 3.

An actuating signal can be sent from the input unit 30 to the control unit 20, so that the control unit 20 transmits the images acquired by the image acquisition unit 10 to the image display unit 40 for display. The input unit 30 includes a manual switch 31 and a turning signal switch 32. According to the actuating signal input thereto, the control unit 20 transmits different acquired images of traffic conditions to the image display unit 40. More specifically, when the driver operates the manual switch 31 to input an actuating signal to the control unit 20, the control unit 20 will transmit the images acquired by the first and the second image acquisition unit 11, 12 for displaying them on the split screen of the image display unit 40 at the same time to show the traffic conditions in front of two lateral sides of the car 1. The driver can know from the images on the split screen whether there is any car coming out from any of the street corners or lanes entrances closely located in front of the left and right sides of the car 1, so as to take necessary action to drive the car more safely. According to an operable embodiment, each time the manual switch 31 is pushed, the control unit 20 can transmit the images to the image display unit 40 for display for a period of 30 seconds to 1 minute, so that the images will soon automatically disappear from the image display unit 40 after the car 1 has passed the street corners or lane entrances. Since the image shown on the left and the right part 41, 42 of the split screen of the image display unit 40 respectively indicates the traffic condition of the street corners or lane entrances at left and right sides of the car, the driver can very easily determine the direction from where another car is approaching to the car.

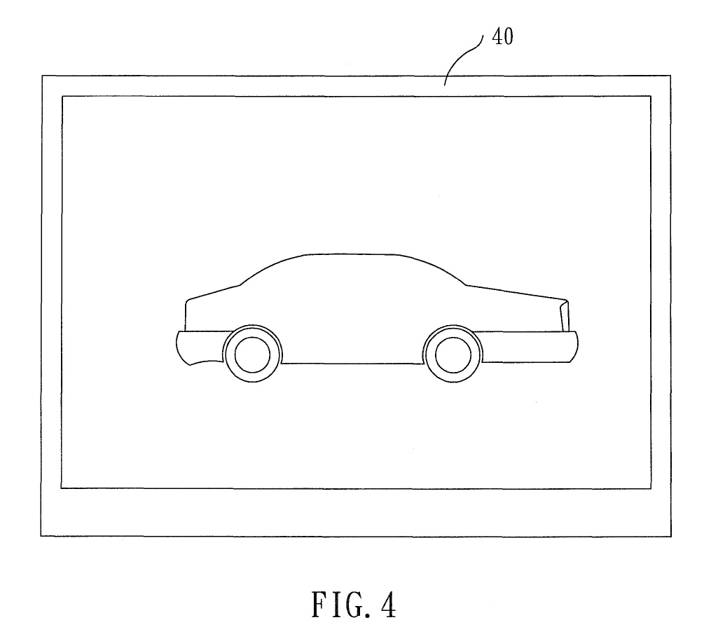

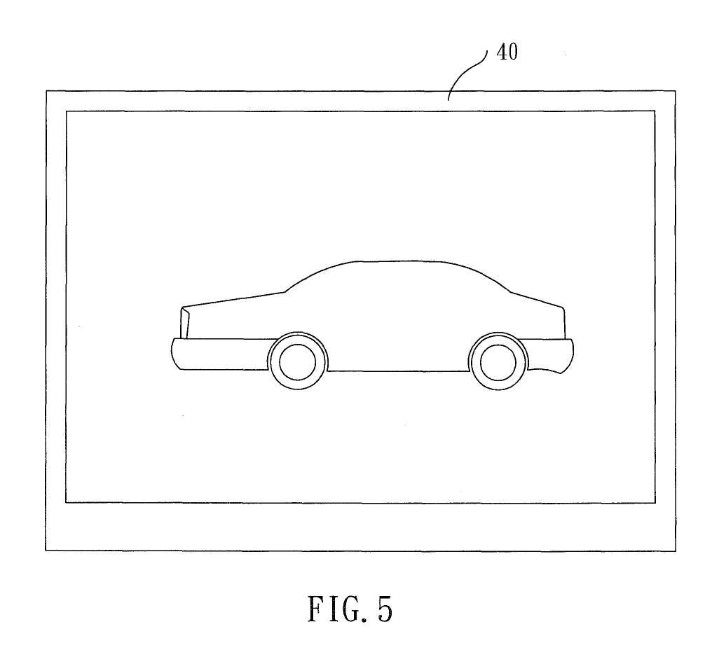

When the car 1 comes to a street corner or a lane entrance and wants to turn, and the driver pushes the turning signal switch 32 to left without pushing the manual switch 31, the control unit 20 will receive an actuating signal from the turning signal switch 32, and only transmits the image acquired by the first image acquisition unit 11 to indicate the traffic condition of the street corner at the left side of the car 1 to the image display unit 40 for display, as shown in FIG. 4. Alternatively, when the driver pushes the turning signal switch 32 to right without pushing the manual switch 31, the control unit 20 receiving the actuating signal from the turning signal switch 32 will transmit only the image acquired by the second image acquisition unit 12 to indicate the traffic condition of the street corner or lane entrance at the right side of the car 1 to the image display unit 40 for display, as shown in FIG. 5.

The car-mount traffic condition surveillance device according to the first embodiment of the present invention can further includes a memory unit 60 for storing important data, such as all the images acquired by the driver using the surveillance device of the present invention. For owners of some vehicles for special purposes, such as engineering trucks, tour buses, rental cars, etc., the use of the surveillance device of the present invention by the driver during driving can be used to determine whether the driver has taken necessary action to drive safely during the whole driving process, and even be used as a basis to determine who should be responsible for an accident, if one happens. The memory unit 60 can be any one of the various currently available memory devices, including but not limited to a removable memory card or a portable storage device, such as a USB flash disk.

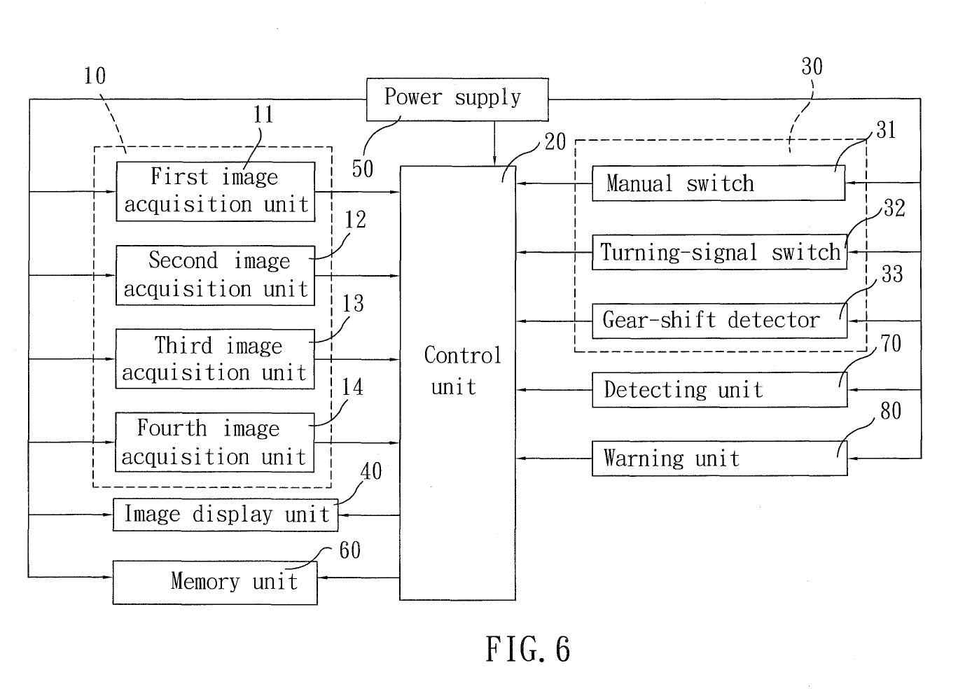

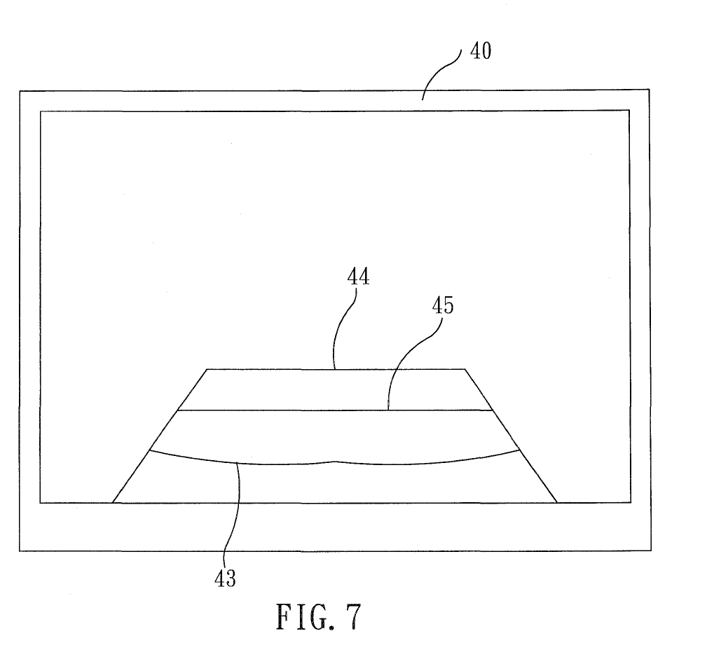

FIG. 6 is a block diagram of a car-mount traffic condition surveillance device according to a second embodiment of the present invention. The second embodiment is different from the first embodiment in that the image acquisition unit 10 further includes a third image acquisition unit 13 mounted to a rear side of the car 1 for acquiring an image of traffic condition closely behind the car 1, and the input unit 30 further includes a gear-shift detector 33. When the driver moves the gear shift rod to reverse gear, the gear-shift detector 33 will transmit a reverse-gear signal to the control unit 20. On receipt of the reverse-gear signal from the gear-shift detector 33, the control unit 20 will immediately transmit the image acquired by the third image acquisition unit 13 to the image display unit 40 to show the traffic condition at the rear side of the car 1. The gear-shift detector 33 can be a reverse signal output device originally equipped on the car. When the reverse signal output device detects that the gear shift rod of the car 1 is pushed to the reverse gear, the reverse light of the car will become on and the reverse signal is transmitted to the control unit 20. FIG. 7 shows the image display unit 40 of the present invention displays an image indicating the traffic condition at a rear side of the car 1. The control unit 20 can show on the image display unit 40 a virtual rear position 43 of the car 1, and a safety line 44 indicating a safety distance between the virtual rear position 43 of the car and an obstacle behind the car 1. The virtual rear position 43 and the safety line 44 can be shown with different colors to distinguish them from each other. For example, the virtual rear position 43 can be shown with a red line while the safety line is a green line. A warning line 45, such as a blue line, can be further shown between the red line and the green line. When the rear obstacle exceeds the warning line 45, it means the car 1 is about to touch the obstacle.

The second embodiment shown in FIG. 6 can further include a detecting unit 70 electrically connected to the control unit 20. The detecting unit 70 includes a first radar unit 71 and a second radar unit 72. As can be seen from FIG. 2, the first radar unit 71 is mounted to a rear left side of the car 1 and the second radar unit 72 is mounted to a rear right side of the car 1 for detecting a distance between the car and a rear obstacle.

The second embodiment shown in FIG. 6 can further include a warning unit 80 electrically connected to the control unit 20. When the control unit 20 receives a signal from the detecting unit 70 informing that the distance between the car and a rear obstacle is smaller than a preset value, such as 45 cm, for example, the control unit 20 will communicate with the warning unit 80 for the latter to produce an alarm sound for warning the driver, so that the driver can more carefully and slowly back the car 1.

The image display unit 40 can be a liquid crystal display (LCD) screen, as shown in FIGS. 3-5. The LCD screen can be independently provided or be integrated into an LCD screen originally equipped on the car. In the latter case, the LCD screen originally equipped on the car can be directly used to display the acquired images. The first, second and third image acquisition units 11, 12 and 13 all can be a camera device.

Further, the manual switch 31 can be a push button or a touch-control screen.

In the second embodiment, the image acquisition unit 10 can further include a fourth image acquisition unit 14 for mounting inside the car 1 to acquire images in the car for the purpose of in-car surveillance. In the case of a vehicle for carrying goods, the fourth image acquisition unit 14 can be mounted in the space accommodating the goods to acquire the goods image for the purpose of surveillance.

The car-mount traffic condition surveillance device of the present invention is able to automatically detect traffic conditions at street corners or lane entrances closely located in front of two lateral sides of the car and provides the driver with real-time traffic conditions at such street corners or lane entrances, so that unexpected collision of the user's car with another car coming out from any of the close street corners or lane entrances can be avoided to ensure good safety in driving.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A car-mount traffic condition surveillance device for acquiring images of street corners or lane entrances closely located in front of two lateral sides of a car, comprising:
an image acquisition unit including a first image acquisition unit for mounting to a front left side of the car and a second image acquisition unit for mounting to a front right side of the car; the first image acquisition unit being able to acquire an image of traffic condition of a street corner or lane entrance closely located in front of the left side of the car, and the second image acquisition unit being able to acquire an image of traffic condition of a street corner or lane entrance closely located in front of the right side of the car;
a control unit being electrically connected to the image acquisition unit and able to integrate the images separately acquired by the first and the second image acquisition unit into one picture for displaying on a split screen with the image from the first image acquisition unit located at a left part of the split screen and the image from the second image acquisition unit located at a right part of the split screen;
an image display unit being electrically connected to the control unit for displaying images transmitted thereto from the control unit;
an input unit being electrically connected to the control unit for a user to input an actuating signal to the control unit, so that the control unit, on receipt of the actuating signal, transmits the images acquired by the image acquisition unit to the image display unit for display; and the input unit including a manual switch for sending an actuating signal to the control unit, so that the control unit immediately transmits the images acquired by the first and the second image acquisition unit to the image display unit for displaying at a left and a right part, respectively, of a split screen on the image display unit; and
a power supply unit being connected to all the above-mentioned units for supplying power needed by these units to operate normally.

2. The car-mount traffic condition surveillance device as claimed in claim 1, wherein the input unit further includes a turning signal switch; the control unit immediately transmitting only the image acquired by the first image acquisition unit to the image display unit for display when receiving a left-turn signal output by the turning signal switch, and immediately transmitting only the image acquired by the second image acquisition unit to the image display unit for display when receiving a right-turn signal output by the turning signal switch.

3. The car-mount traffic condition surveillance device as claimed in claim 1, wherein the image display unit is an LCD screen originally equipped on the car.

4. The car-mount traffic condition surveillance device as claimed in claim 1, further comprising a memory unit electrically connected to the control unit for storing the images that are transmitted by the control unit to the image display unit for display.

5. The car-mount traffic condition surveillance device as claimed in claim 1, wherein the image acquisition unit further includes a third image acquisition unit being mounted to a rear side of the car for acquiring an image showing a traffic condition at the rear side of the car; and wherein the input unit further includes a gear-shift detector, such that the control unit, on receipt of a reverse-gear signal from the gear-shift detector, immediately transmits an image acquired by the third image acquisition unit to the image display unit for display.

6. The car-mount traffic condition surveillance device as claimed in claim 5, wherein the gear-shift detector is a reverse-gear signal output device originally equipped on the car.

7. The car-mount traffic condition surveillance device as claimed in claim 5, wherein the control unit is able to display on the image display unit a virtual rear position of the car and a safety range between the virtual rear position of the car and an obstacle located behind the car.

8. The car-mount traffic condition surveillance device as claimed in claim 5, further comprising a detecting unit electrically connected to the control unit; and the detecting unit including a first radar unit mounted to a rear left side of the car and a second radar unit mounted to a rear right side of the car for detecting a distance between the rear side of the car and an obstacle behind the car.

9. The car-mount traffic condition surveillance device as claimed in claim 8, further comprising a warning unit electrically connected to the control unit for producing an alarm sound when the control unit receives a signal from the detecting unit indicating an obstacle closely behind the car.
